(19) United States
(12) Patent Application Publication
(10) Pub. No.: US 2020/0312257 A1
(43) Pub. Date: Oct. 1, 2020

(54) DISPLAY APPARATUS

(71) Applicant: SHARP KABUSHIKI KAISHA, Sakai City (JP)

(72) Inventors: KOHJI NAGASAKA, Sakai City (JP); KUNIAKI TANAKA, Sakai City (JP); FUMIKAZU SHIMOSHIKIRYOH, Sakai City (JP)

(21) Appl. No.: 16/824,122

(22) Filed: Mar. 19, 2020

(30) Foreign Application Priority Data
Mar. 26, 2019 (JP) 2019-059000

(51) Int. Cl. G09G 3/36

(52) U.S. Cl. CPC G09G 3/3607; G09G 2320/0666; G09G 3/3648

(57) ABSTRACT

A display apparatus includes a first substrate unit, a second substrate unit, and a display panel. The first substrate unit is a substrate unit on which a driver circuit is mounted. The driver circuit outputs multiple driver output signals. The second substrate unit includes branching lines, through which one driver output signal is caused to branch to multiple branching signals, for each of the driver output signals. The display panel receives the branching signals.

### BACKGROUND

### 1. Field

The present disclosure relates to a display apparatus.

### 2. Description of the Related Art

Heretofore, thin film transistor (TFT) liquid crystal displays driven by using the active-matrix method have been widely used. In the active-matrix method, electrodes, which are disposed in a grid on a transparent conductive film, are used to control the pixels. A known display is a display having 4K (3840×2160) resolution or a display having 8K (7680×4320) resolution which uses TFT liquid crystal or the like. Japanese Unexamined Patent Application Publication No. 2001-272689 discloses an inexpensive manufacture method for implementing a liquid crystal display apparatus having a low resolution.

However, the related art described above has faced the following challenge. That is, in the case of manufacturing displays having different resolutions, even if the screen sizes are the same, new components compatible with each resolution have to be used, resulting in high cost. The method disclosed in Japanese Unexamined Patent Application Publication No. 2001-272689 enables a TFT substrate to be used also in manufacturing displays having the same screen size and different resolutions. However, the color filter substrate, the driving ICs, and the driving circuit are to be changed, which is susceptible to improvement.

It is desirable to widen applicability of the components in manufacturing display apparatuses (displays) having different resolutions.

### SUMMARY

A display apparatus according to one aspect of the present disclosure includes a first substrate unit, a second substrate unit, and a display panel. The first substrate unit is a substrate unit on which a driver circuit is mounted. The driver circuit outputs multiple driver output signals. The second substrate unit includes branching lines, through which one driver output signal is caused to branch to multiple branching signals, for each of the driver output signals. The display panel receives the branching signals.

### BRIEF DESCRIPTION OF THE DRAWINGS

FIG. 1 is a diagram illustrating a display apparatus according to a first embodiment;

FIGS. 2A to 2D are diagrams illustrating members used in the aspects including the first embodiment, and the flow of a video signal or a driving signal;

FIGS. 3A and 3B are diagrams illustrating examples of pixels included in liquid crystal panels;

FIG. 4 is a diagram illustrating a display apparatus according to a second embodiment;

FIGS. 5A and 5B are diagrams illustrating examples of pixels included in liquid crystal panels;

FIG. 6 is a diagram illustrating a display apparatus according to a third embodiment;

FIG. 7 is a diagram illustrating a display apparatus according to a fourth embodiment; and

FIG. 8 is a diagram illustrating a display apparatus according to a fifth embodiment.

### DESCRIPTION OF THE EMBODIMENTS

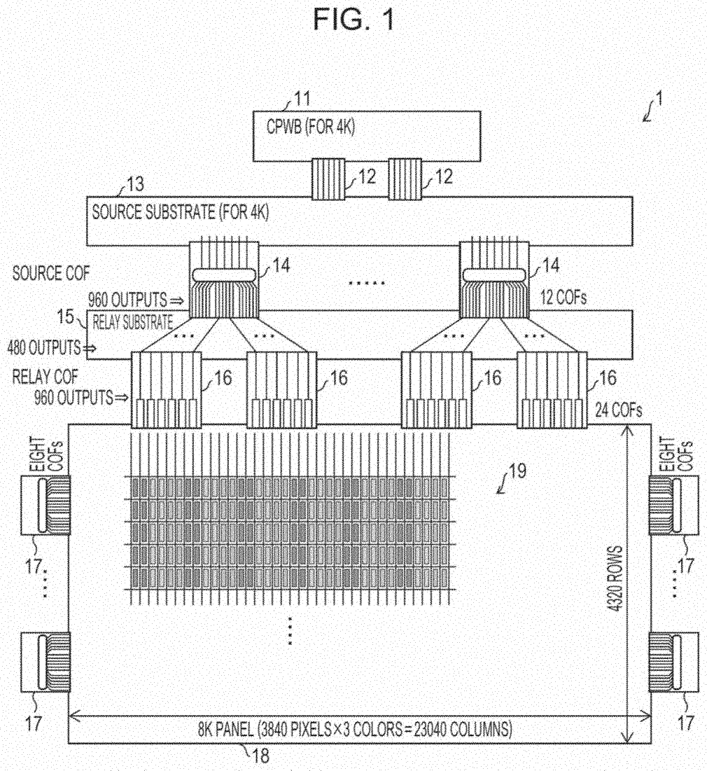

Embodiments of the present disclosure will be described in detail below by referring to FIGS. 1 to 8. If not otherwise indicated particularly, the configurations described in the embodiments are not intended to limit the scope of the disclosure only to these, and are merely exemplary descriptions.

### First Embodiment

One embodiment of the present disclosure will be described below by referring to FIGS. 1 to 3B. A first embodiment describes an exemplary display apparatus for widening applicability of the components. In the first embodiment and its subsequent embodiments, an example in which components for high-definition displays are used in manufacturing low-definition displays will be described by taking, as an example, the case in which components for 8K-resolution displays are used in manufacturing 4K-resolution displays. However, this is not limiting. For example, the embodiments may be applied also to the case in which components for 8K-resolution or 4K-resolution displays are used in manufacturing 2K-resolution (FHD: full high definition) displays.

FIG. 1 is a conceptual diagram illustrating a display apparatus 1 according to the first embodiment. In Firs 1, some members included in the display apparatus 1 are not illustrated.

In FIG. 1, a control printed wired board (CPWB) 11 supplies a liquid crystal panel (display panel) 18 with driving signals for displaying a 4K-resolution video. Flexible flat cables (FFC) 12 are flexible cables connecting the CPWB 11 to a source substrate 13. The source substrate 13 is a source substrate for 4K-resolution video signals. Source drivers (first substrate units, source COFs (chips on film)) 14 exert control for supplying source signals for electrodes (source lines) disposed in the vertical direction on the liquid crystal panel 18. Each of the source drivers 14 and gate drivers 17 described below may be formed in such a manner that an IC chip for driving the liquid crystal panel 18 is mounted on a film base material such as a polyimide. The source signals and gate signals described below are included in driver output signals. In the example in FIG. 1, the number of source signals which are output from one source driver 14 is 960. A relay substrate 15 relays source signals supplied from the source drivers 14, and outputs the signals to relay COFs 16. Each of the relay COFs (second substrate units) 16 is a COF including branching lines for causing one input source signal to branch to multiple branching signals. As illustrated in FIG. 1, the branching lines, through which one driver output signal is caused to branch, may be adjacent to each other. This facilitates manufacture of the relay COFs 16. In the first embodiment, the relay COFs 16 cause one source signal to branch to two branching signals. The relay substrate 15 branch connects one source driver 14 to two relay COFs 16 whose number matches the number described above. The gate drivers (gate COFs) 17 exert control. for supplying the gate signals to electrodes (gate lines) disposed in the horizontal direction in the liquid crystal panel 18. In the example in FIG. 1, the number of gate signals which are output from one gate driver 17 is 540.

The array substrate of the liquid crystal panel 18 includes multiple source lines (also called data lines) and multiple gate lines. The source lines are formed as video signal lines so as to extend in the vertical direction and be arranged in parallel horizontally. The gate lines are formed as scanning signal lines so as to extend in the horizontal direction and be arranged in parallel vertically. That is, the source lines and the gate lines are arranged in a grid. At each of the intersection portions between the source lines and the gate lines, a thin film transistor (TFT) is disposed. The source line is connected to the source of the TFT, and the gate line is connected to the gate of the TFT. The drain of the TFT is connected a pixel electrode. In the state in which a voltage is applied to the source of the TFT, when the gate of the TFT receives a signal (voltage), a current flows between the source and the drain, and a charge is accumulated in the pixel electrode (the pixel electrode is charged).

In the liquid crystal panel 18, an electric field produced between the pixel electrodes and the counter electrode causes the liquid crystal molecules to rotate. The liquid crystal panel 18 uses the change in transmittance, which is caused by the orientation of the liquid crystal molecules, to display a video.

In screen display performed by the liquid crystal panel 18, any of the so-called dot sequential driving operation method, the so-called line sequential driving operation method, and the so-called frame sequential driving operation method may be used. The description will be made by taking an active-matrix liquid crystal panel as the liquid crystal panel 18. However, this is not limiting. A passive-matrix liquid crystal panel may be used.

In the example in FIG. 1, the number of source lines is 23040, and the number of relay COFs 16 is 24 (=23040/960). The number of gate lines is 4320, and the number of gate drivers 17 is 8 (=4320/540).

For example, a color filter 19 is disposed in front of the counter electrode and is used to convert a monochrome image into a color image. The color filter 19 causes red, green, or blue (R, G, or B) to be provided to every two columns of the pixels f the liquid crystal panel 18. In other words with a postscript, the liquid crystal panel 18 includes the color filter 19 in which the same color is set for the branching lines through which one source signal is caused to branch. Thus, the branching source signals may be used to control the same-color pixels. In addition, every two columns of the color filter 19 are made to have the same color. Thus, the number of driving operations in the column direction may be reduced to a half, achieving a display whose resolution is reduced by half.

As the CPWB 11, the FFCs 12, the source substrate 13, the source drivers 14, the gate drivers 17, and TFT masks (not illustrated), those of the related art may be used. Thus, control in the horizontal direction of the liquid crystal panel 18 may be performed for each row by using a gate signal as in the related art, and control in the vertical direction is performed for every two columns by using branching signals.

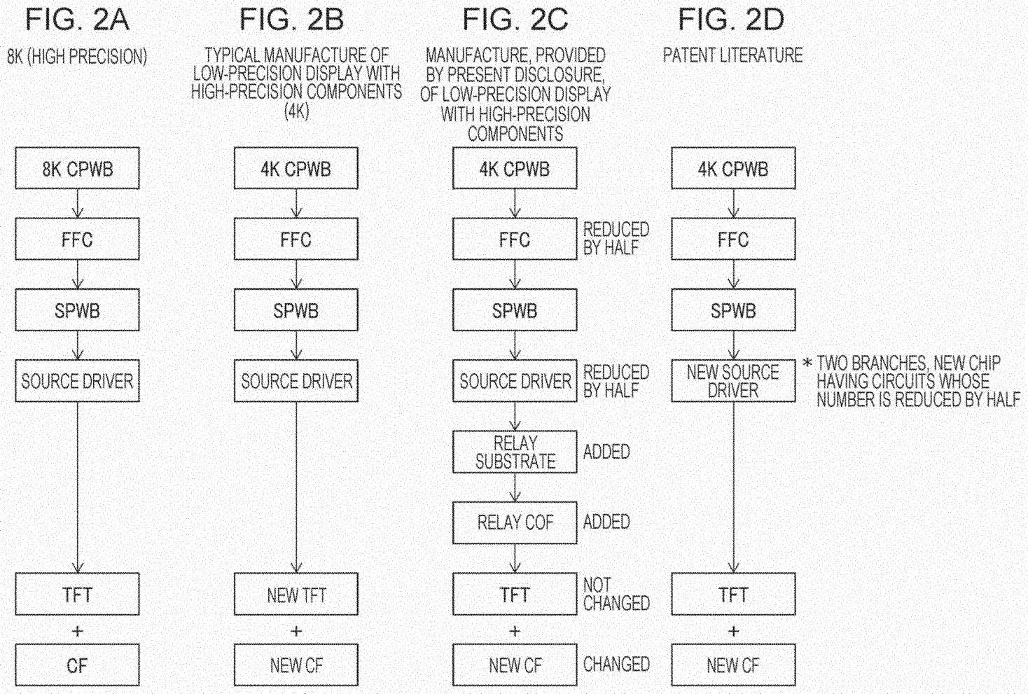

As the CPWB 11, a control substrate, for 4K, of the related art may be used, achieving a reduction in the circuit size compared with a control substrate for 8K. The amount of an output signal is as less as that of a 4K signal. Thus, the data amount of output signals to the source drivers 14 is small, achieving a great reduction in the number of signal transmission lines. As a result, the number of FFCs 12 connecting the CPWB 11 to the source substrate 13 may be reduced. FIGS. 2A to 2D are diagrams illustrating members used in the aspects including the first embodiment and the flow of a video signal or a driving signal.

FIG. 2B shows that the case, in which a 4K-resolution display is manufactured by using components of an 8K-resolution display corresponding to FIG. 2A, typically involves new TFT masks and a new color filter. FIG. 2C illustrates the configuration according to the first embodiment in which new TFT masks are unnecessary in the case described above. FIG. 2D illustrates the configuration according to Japanese Unexamined Patent Application Publication No. 2001-272689 applied to the case described above. The configuration involves new source drivers. The relay substrate 15 and the relay COFs 16 are components which are greatly inexpensive and which are easy to manufacture compared with TFT masks and driver circuits such as source drivers.

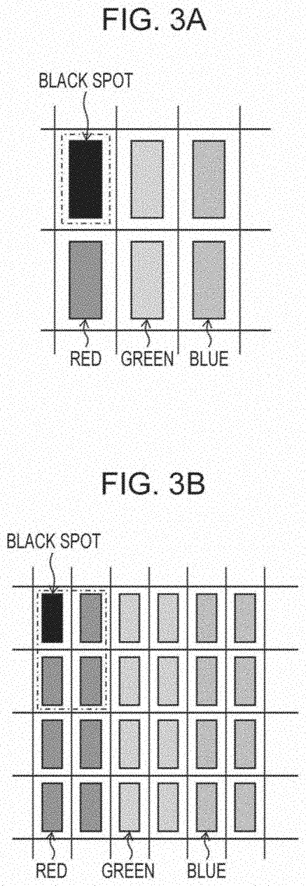

In the FHD of the related art, as illustrated in FIG. 3A, display of one pixel, for example, a red pixel, is performed by using a single pixel. As illustrated in FIG. 3B, in the first embodiment, display of one pixel is performed by using four pixels. Even in the case where one pixel fails to be displayed because the pixel is displayed in black, the three pixels among the four pixels may be displayed in the first embodiment. In addition, the size of the defect pixel is small, causing the display problem to be almost eliminated and resulting in unnecessity of counting the pixel as a black spot which is a type of defect. Accordingly, while, in the related art, when there are a certain number of black spots, the entire panel is subjected to a process for recovery from the defect, in the first embodiment, the process for recovery from the defect is not performed. As a result, the process yield is improved. The same is true for the configurations according to second to fifth embodiments described below.

As described above, the display apparatus 1 according to the first embodiment has the configuration including the first substrate units (source drivers) 14, the second substrate units (relay COFs) 16, and the display panel (liquid crystal panel) 18. On each of the first substrate units (source drivers) 14, a driver circuit which outputs multiple driver output signals is mounted. Each of the second substrate units (relay COFs) 16 includes branching lines, through which one driver output signal is caused to branch to multiple branching signals, for each of the multiple driver output signals. The display panel (liquid crystal panel) 18 receives the branching signals. The configuration described above enables a video to be played back by using the liquid crystal panel 18 for low resolution only by adding inexpensive members, that is, the relay substrate 15 and the relay COFs 16, except the new color filter 19. Thus, new source drivers and gate drivers, and new TFT masks, which are expensive, are unnecessary. That is, applicability of the expensive components in the case of manufacturing display apparatuses having different resolutions may be widened.

### Second Embodiment

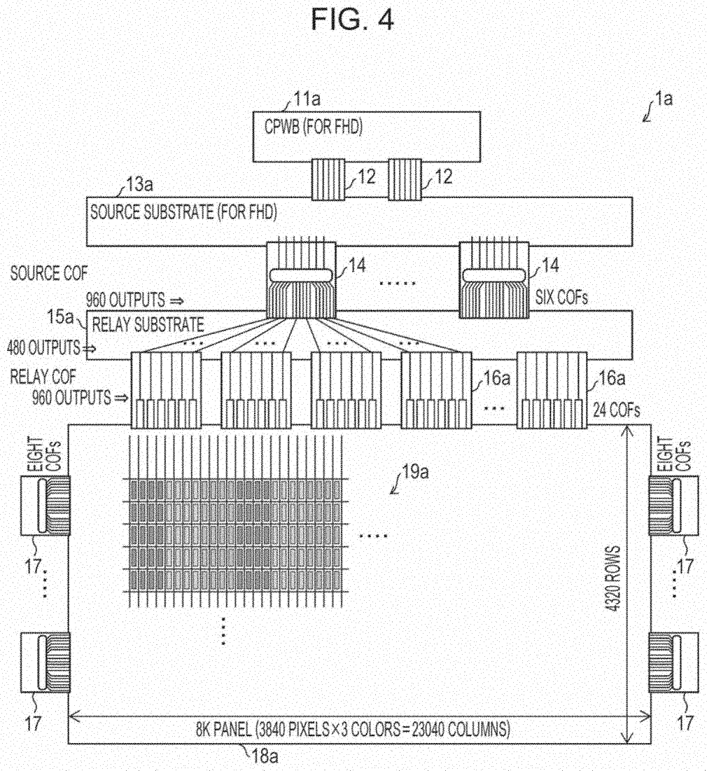

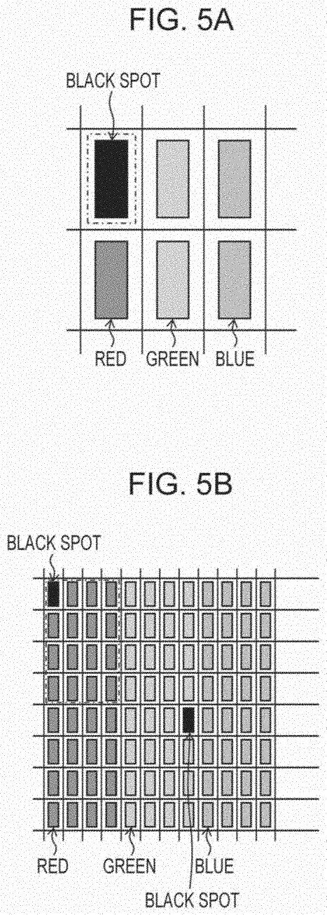

A second embodiment of the present disclosure will be described by referring to FIGS. 4 to 5B. For convenience of description, components having functions identical to those of components described in the embodiment described above are designated with identical reference characters, and will not be described. The same is true for the embodiments described below. In the second embodiment, an exemplary display apparatus which displays a video having a resolution which is further lower than that in the first embodiment will be described.

FIG. 4 is a conceptual diagram illustrating a display apparatus 1a according to the second embodiment. FIG. 4 does not illustrate some members included in the display apparatus 1a.

Relay COFs 16a according to the second embodiment cause one input source signal to branch to four branching signals. A relay substrate 15a connects one source driver 14 to four relay COFs 16a whose number matches the number described above. That is, while the number of relay COFs 16a included in the display apparatus 1a is 24, the number of source drivers 14 is 6 which is a half of that in the display apparatus 1.

The number of source drivers 14 is reduced by half. Thus, a CPWB 11a for FHD may be used for an 8K-resolution display. A color filter 19a according to the second embodiment is a filter in which R, G, or B is provided for every four rows of the pixels of a liquid. crystal panel 18a. Every four rows of the color filter 19a are made to have the same color. Thus, the number of driving operations in the column direction may be reduced to a quarter, achieving a display whose resolution is reduced to a quarter.

Also in the second embodiment, as the CPWB 11a, the FFCs 12, a source substrate 13a, the source drivers 14, the gate drivers 17, and the TFT masks (not illustrated), those of the related art may be used. Thus, control in the horizontal direction of the liquid crystal panel 18a may be performed for each row by using a gate signal as in the related art, and control in the vertical direction is performed for every four columns by using branching signals.

In an FED display of the related art, as illustrated in FIG. 5A, display of one pixel, for example, a red pixel, is performed by using a single pixel. As illustrated in FIG. 5B, in the second embodiment, display of one pixel is performed by using 16 pixels. Even in the case where one pixel fails to be displayed because the pixel is displayed in black, the 15 pixels among the 16 pixels may be displayed in the second embodiment. In addition, the size of the defect pixel is small, causing the display problem to be almost eliminated and resulting in unnecessity of counting the pixel as a black spot which is a type of defect. Accordingly, while, in the related art, when there are a certain number of black spots, the entire panel is subjected to a process for recovery from the defect, in the second embodiment, the process for recovery from the defect is not performed. As a result, the process yield is greatly improved.

### Third Embodiment

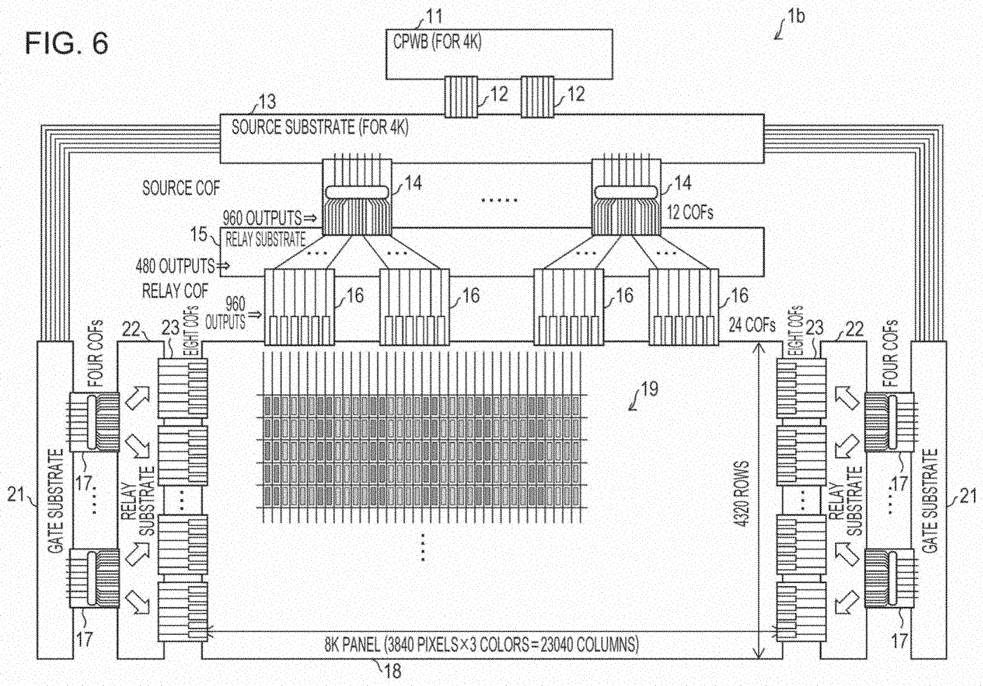

A third embodiment of the present disclosure will be described by referring to FIG. 6. in the third embodiment, the configuration in which, in addition to the source signals, the gate signals are also caused to branch will be described.

FIG. 6 is a conceptual diagram illustrating a display apparatus 1b according to the third embodiment. FIG. 6 does not illustrate some members included in the display apparatus 1b.

As illustrated in FIG. 6, the display apparatus 1b according to the third embodiment includes a gate substrate 21, a relay substrate 22, and relay COFs (second substrate units) 23. The gate substrate 21 is a gate substrate for 4K-resolution video signal. The relay substrate 22 relays the gate signals supplied from the gate drivers (first substrate units) 17, and supplies the relayed signals to the relay COFs 23.

As illustrated in FIG. 6, signals may be input to the gate substrate 21 through the source substrate 13. Each of the relay COFs 23 is a COF including branching lines through which one input gate signal is caused to branch to multiple branching signals. In the third embodiment, the relay COF 23 causes one gate signal to branch to two branching signals. In addition, the relay substrate 22 connects one gate driver 17 to two relay COFs 23 whose number matches the number described above. As a result, when the number of gate lines is 4320, the number of gate drivers 17 in the third embodiment is four which is a half of that in the first embodiment, and the number f relay COFs 23 is eight.

The CPWB 11 for 4K resolution is used for the liquid crystal panel 18 for 8K resolution. Thus, while the configuration according to the first embodiment involves doubling the horizontal period for driving the gate drivers 17, the configuration according to the third embodiment may use the horizontal period for driving the typical 4K-resolution gate drivers 17 since the number of gate drivers 17 that. are used may be reduced to a half.

### Fourth Embodiment

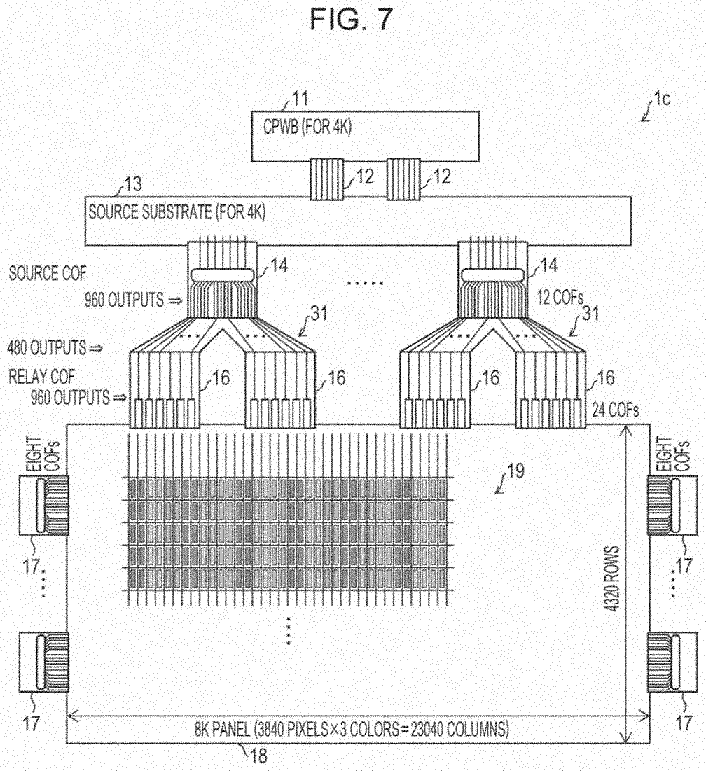

A fourth embodiment of the present disclosure will be described by referring to FIG. 7. In the fourth embodiment, an exemplary configuration in which the first substrate units and the second substrate units are included on the same substrate will be described.

FIG. 7 is a conceptual diagram illustrating a display apparatus 1c according to the fourth embodiment. In the display apparatus 1c, the source drivers 14 and the relay COFs 16 are included on an identical film substrate 31. Thus, the display apparatus 1c which does not include the relay substrate 15 for connecting the source drivers 14 to the relay COFs 16 may achieve functions equivalent to those of the display apparatus 1 according to the first embodiment. It may be understood that the relay COFs 16 are included in the source drivers 14.

### Fifth Embodiment

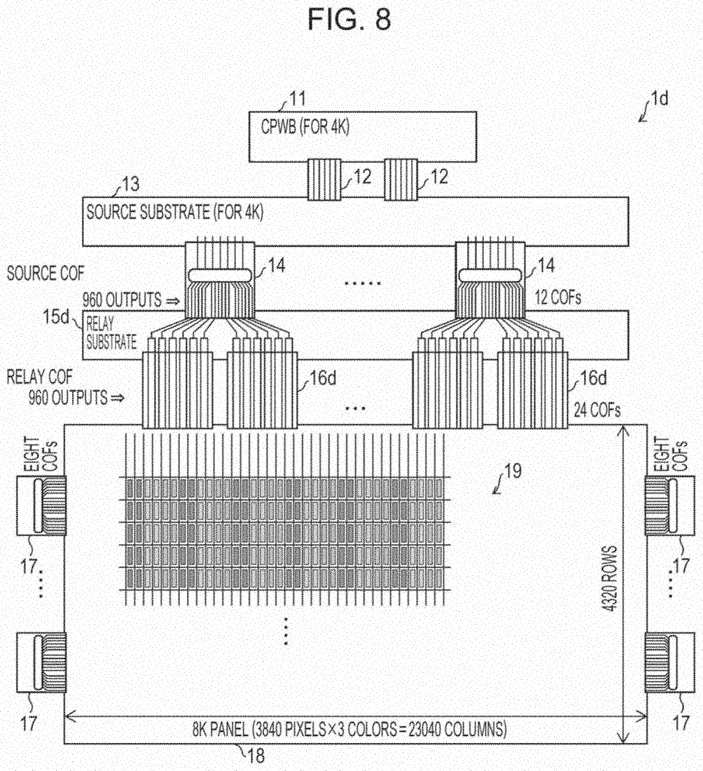

A fifth embodiment of the present disclosure will be described by referring to FIG. 8. In the fifth embodiment, an exemplary configuration in which driver output signals are caused to branch on the relay substrate will be described.

FIG. 8 is a conceptual diagram illustrating a display apparatus 1d according to the fifth embodiment. In the display apparatus 1d, source signals are caused to branch on a relay substrate 15d, not on relay COFs 16d. That is, the relay COFs 16d according to the fifth embodiment have circuits on which branching is not performed, and the relay substrate 15d includes branching lines through which one source signal is caused to branch to two branching signals. It may be understood that the relay substrate 15d according to the fifth embodiment corresponds to the second substrate units described above.

Application of the configuration according to the fifth embodiment enables components of the source drivers 14 and the like to be used in manufacturing displays having various resolutions by changing the wiring pattern of the relay substrate and the color filter.

### Additional Statements according to the First to Fifth Embodiments

Also in the configurations according to the first and third to fifth embodiments, the number of branching signals obtained through the branching lines, which are included on the relay COFs 16, the relay COFs 23, or the relay substrate 15d and through which one driver signal is caused to branch, is not limited to two. For example, the number of branching signals may be four as in the configuration according to the second embodiment. Alternatively, the number of branching signals may be three or five or more. In addition, the liquid crystal panel 18 may have a configuration including a color filter in which red, green, or blue (R, G, or B) is provided to every pixels in columns or rows whose number is equal to the number of branching signals obtained by causing one driver signal to branch by using the branching lines.

The third embodiment may have a configuration in which only the gate signals are caused to branch and the source signals are not caused to branch. That is, the following configuration may be employed: the display apparatus 1b does not include the relay substrate 15 and the relay COFs 16, and includes 24 source drivers 14; the outputs from the source drivers 14 are input directly to the source lines of the liquid crystal panel 18. In addition, when the gate signals are caused to branch, the liquid crystal panel 18 may have a configuration including a horizontally-striped color filter in which the same color is provided in the longitudinal direction with respect to the target branching lines.

In the configurations according to the second and third embodiments, the source drivers 14 and the relay COFs 16 may be included on the same film substrate 31. In the third embodiment, the gate drivers 17 and the relay COFs 23 may be included on the same film substrate.

In the configurations according to the fifth embodiment, branching lines included on the relay substrate 15d do not hinder at least some of the relay COFs 16d from including branching lines. That is, a configuration may be employed in which a circuit which is disposed on the relay substrate 15d and which connects a first source driver 14 to a first relay COF 16d does not include branching lines and the first relay COF 16d includes branching lines, and in which a circuit which is disposed on the relay substrate 15d and which connects a second source driver 14 to a second relay COF 16d includes branching lines and the second relay COF 16d does not include branching lines.

The configuration according to the fifth embodiment may be applied to the configurations according to the second and third embodiments. That is, the second embodiment may have a configuration in which branching lines included, not on the relay COFs 16, but on the relay substrate 15 are used to cause one input source signal to branch to four branching signals. The third embodiment may have a configuration in which at least the relay COFs 16 or the relay COFs 23 do not include branching lines, and in which branching lines included on at least the relay substrate 15 or the relay substrate 22 are used to cause one input driver output signal to branch to multiple branching signals.

### CONCLUSION

A display apparatus (1) according to a first aspect of the present disclosure includes a first substrate unit (14, 17), a second substrate unit (15d, 16, 23), and a display panel (18). The first substrate unit is a substrate unit on which a driver circuit is mounted. The driver circuit outputs multiple driver output signals. The second substrate unit includes branching lines, through which one driver output signal is caused to branch to multiple branching signals, for each of the driver output signals. The display panel receives the branching signals. The configuration described above may widen applicability of the components in the case of manufacturing display apparatuses having different resolutions.

The display apparatus according to a second aspect of the present disclosure may have a configuration in which, in the first aspect described above, the first substrate unit and the second substrate unit are included on an identical substrate (31). The configuration described above does not involve manufacturing multiple substrates individually.

The display apparatus according to a third aspect of the present disclosure may have a configuration in which, in the first or second aspect described above, the display panel includes a color filter (19) in which an identical color is provided for the branching lines through which one driver output signal is caused to branch. The configuration described above enables the driver output signals, which have been caused to branch, to be used to control pixels of the same color.

The display apparatus according to a fourth aspect. of the present disclosure may have a configuration in which, in any one of the first to third aspects described above, the first substrate unit includes a source driver which outputs source signals as the driver output signals. The configuration described above enables the source drivers to be used in the case of manufacturing display apparatuses having different resolutions.

The display apparatus according to a fifth aspect of the present disclosure may have a configuration in which, in any one of the first to third aspects described above, the first substrate unit includes a gate driver which outputs gate signals as the driver output signals. The configuration described above enables the gate drivers to be used in the case of manufacturing display apparatuses having different resolutions.

The display apparatus according to a sixth aspect of the present disclosure may have a configuration in which, in any one of the first to fifth aspects described above, the branching lines through which one driver output, signal is caused to branch are adjacent to each other. The configuration described above facilitates manufacture of the second substrate unit.

The display apparatus according to a seventh aspect of the present disclosure may have a configuration in which, in any one of the first to sixth aspects described above, the branching lines through which one driver output signal is caused to branch are equal in number to two. The configuration described above enables one driver output signal to be used to control the pixels in two columns (or two rows).

The display apparatus according to an eighth aspect of the present disclosure may have a configuration in which, in any one of the first to sixth aspects described above, the branching lines through which one driver output signal is caused to branch are equal in number to four. The configuration described above enables one driver output signal to be used to control the pixels in four columns (or four rows).

The present disclosure is not limited to the embodiments described above. Various changes may be made in the scope of the claims. Embodiments obtained by appropriately combining technical units disclosed in the different embodiments are also encompassed in the technical scope of the present disclosure. A combination of technical units disclosed in the embodiments described above may form novel technical characteristics.

The present disclosure contains subject matter related to that disclosed in Japanese Priority Patent Application JP 2019-059000 filed in the Japan Patent Office on Mar. 26, 2019, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a first substrate unit that is a substrate unit on which a driver circuit is mounted, the driver circuit outputting a plurality of driver output, signals;
a second substrate unit that includes branching lines, through which one driver output signal is caused to branch to a plurality of branching signals, for each of the plurality of driver output signals; and
a display panel that receives the plurality of branching signals.

2. The display apparatus according to claim 1,
wherein the first substrate unit and the second substrate unit are included on an identical substrate.

3. The display apparatus according to claim 1,
wherein the display panel includes a color filter in which an identical color is provided for the branching lines through which one driver output signal is caused to branch.

4. The display apparatus according to claim 1,
wherein the first substrate unit includes a source driver which outputs source signals as the plurality of driver output signals.

5. The display apparatus according to claim 1,
wherein the first substrate unit includes a gate driver which outputs gate signals as the plurality of driver output signals.

6. The display apparatus according to claim 1,
wherein the branching lines through which one driver output signal is caused to branch are adjacent to each other.

7. The display apparatus according to claim 1,
wherein the branching lines through which one driver output signal is caused to branch are equal in number to two.

8. The display apparatus according to claim 1,
wherein the branching lines through which one driver output signal is caused to branch are equal in number to four.
